(19) United States
(12) Patent Application Publication
(10) Pub. No.: US 2017/0368670 A1
(43) Pub. Date: Dec. 28, 2017

(54) RATCHET WRENCH STRUCTURE

(71) Applicant: YUE JEI INDUSTRIAL CO., LTD., Taichung City (TW)

(72) Inventor: CHI-LIANG CHEN, Taichung City (TW)

(21) Appl. No.: 15/194,369

(22) Filed: Jun. 27, 2016

(51) Int. Cl. B25B 13/46

(52) U.S. Cl. CPC B25B 13/468; B25B 13/463

(57) ABSTRACT

A ratchet wrench structure includes a body having a head portion with a first, second, and third housings connected; a ratchet block rotatably disposed in the first housing and peripherally provided with plural teeth; two locking members having a flat top surface with a pillar thereon and an opposite flat bottom surface, and disposed in the third housing and laterally movable for engaging the teeth, with a resilient member between the two locking members; a direction controller disposed in the second housing and having a direction controlling recess for receiving the pillars; and a positioning device. The direction controlling recess has an opening end expanding outward. The positioning device positions the direction controller, so as to drive the two locking members to engage the ratchet block. Therefore, the ratchet block is controlled to drive an object in clockwise or counterclockwise direction.

### BACKGROUND OF THE INVENTION

### 1. Field of the Invention

The present invention relates to ratchet wrench structures, and more particularly, to a ratchet wrench structure with two toothed locking members.

### 2. Description of the Related Art

There are various kinds of ratchet wrenches nowadays, each having different structures and achieving the same effect. Usually, ratchet wrenches are further categorized into two types, respectively the type with one toothed locking member and with two toothed locking members. The ratchet wrench with two toothed locking members mainly engages the ratchet block by one of the locking members separately in order to drive an object in clockwise or counterclockwise direction.

However, the ratchet wrench with two locking members is usually provided with a spring disposed between the two locking members, such that the space built in the wrench body shall be considered when installing the two locking members. If the space thereof is relatively small or without special designation, the two locking members are difficult to be installed, hindering the overall assembling process. Further, some manufacturers take the space limitation into consideration and form the two locking members into a structure with a flat shape, such that the locking members are allowed to pass through the relatively narrow space and then installed therein. However, the structural strength of the two locking members is thereby weakened, failing to facilitate the usage thereof. Such issue shall be improved.

### SUMMARY OF THE INVENTION

For improving aforementioned issues, embodiments of the present invention disclose a ratchet wrench structure, wherein the direction controlling recess expands outward. When the pillars of the two locking members are being installed therein, the two locking members are not necessary to be pressed or resisted against each other for compressing the resilient member disposed therebetween, facilitating the installation. Also, the top surface and the bottom surface of the two locking members are flat, such that the original structural strength is kept, and the torque performance is maintained.

For achieving the aforementioned objectives, embodiment of the present invention provides a ratchet wrench structure, comprising:

a body provided with a head portion on one end thereof, the head portion provided with a first side and a second side in opposite to the first side, a first housing passing through the first side and the second side, one side of the first housing connected with a second housing, the second housing opening toward the first side, a third housing disposed between and connected with the first housing and the second housing;

a ratchet block rotatably disposed in the first housing and peripherally provided with plural teeth;

two locking members disposed in the third housing and laterally movable, one side of the locking members provided with a tooth portion engaging the ratchet block, a resilient member disposed between the two locking members, each locking member provided with a flat top surface and a flat bottom surface in opposite to the top surface, each top surface provided with a protruding pillar, respectively;

a direction controller pivotally disposed in the second housing, at an upper end thereof provided with a switch portion, a lower end thereof provided with a holding portion, and a receiving portion disposed between the switch portion and the holding portion, the switch portion and the holding portion mutually spaced, the receiving portion partially receiving the two locking members, the holding portion holding the bottom surfaces of the two locking members, a direction controlling recess disposed at a bottom lateral side of the switch portion facing the holding portion, the direction controlling recess receiving the pillars of the two locking members and provided with an opening end expanding outward; and

a positioning device disposed between the direction controller and an inner wall of the second housing and positioning the direction controller, the direction controller thereby driving the two locking members to engage the ratchet block such that the ratchet block is controlled to drive an object in clockwise or counterclockwise direction.

In an embodiment of the present invention, a ring recess disposed in the first housing adjacent to the first side. The ring recess is arranged in axial alignment with the first housing. One end of the ratchet block is peripherally provided with a ring notch. A C-clamp is disposed between the ring notch and the ring recess.

In an embodiment of the present invention, a notch is disposed between the ring recess and the third housing.

In an embodiment of the present invention, the notch is positioned in vertical to a central axis of the first housing.

In an embodiment of the present invention, the width of the opening end of the direction controlling recess is larger than a normal distance between the pillars of the two locking members when the resilient member is not compressed.

With such configuration, during the assembling of the present invention, the two locking members are efficiently installed into the direction controlling recess without compressing the resilient member, facilitating the assembling process.

In addition, the notch of the present invention enables the pillars of the two locking member to freely pass through the notch and efficiently enter the direction controlling recess of the direction controller, further facilitating the assembling process. Also, a flat-shaped top surface and bottom surface of the two locking members are maintained, keeping the completion of the structure of the two locking members, such that the torque provided by the present invention is prevented from being adversely affected.

### BRIEF DESCRIPTION OF THE DRAWINGS

FIG. 1 is a perspective view of the ratchet wrench structure in accordance with the present invention.

FIG. 2 is an exploded view of the ratchet wrench structure in accordance with the present invention.

FIG. 3 is a schematic view partially illustrating the direction controller from another view point.

FIG. 4 is a cross sectional view of the ratchet wrench structure taken along the line 4-4 in FIG. 1.

FIG. 5 is a schematic view illustrating the locking members being installed into the direction controller through the notch.

FIG. 6 is a cross-sectional view taken along the line 6-6 in FIG. 4.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

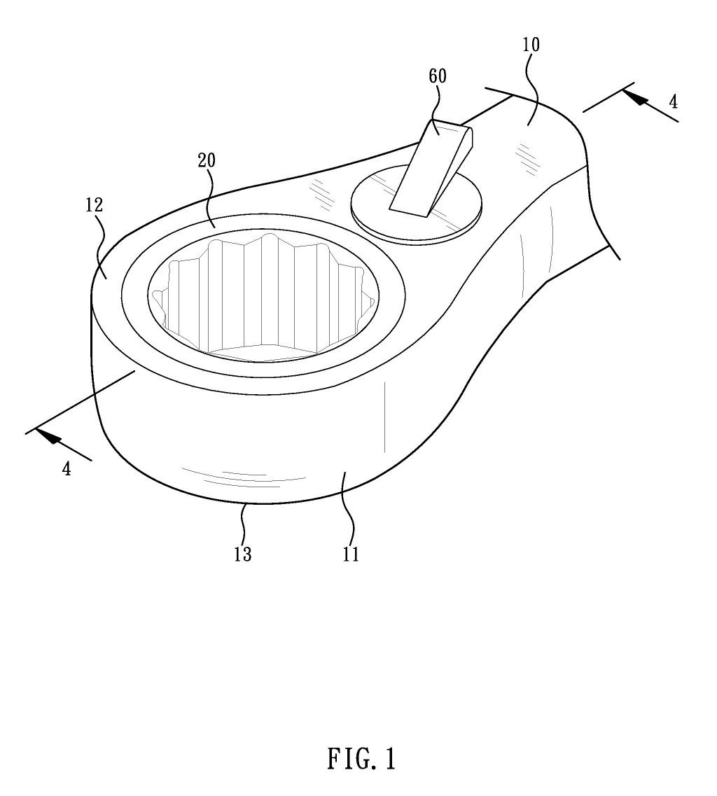

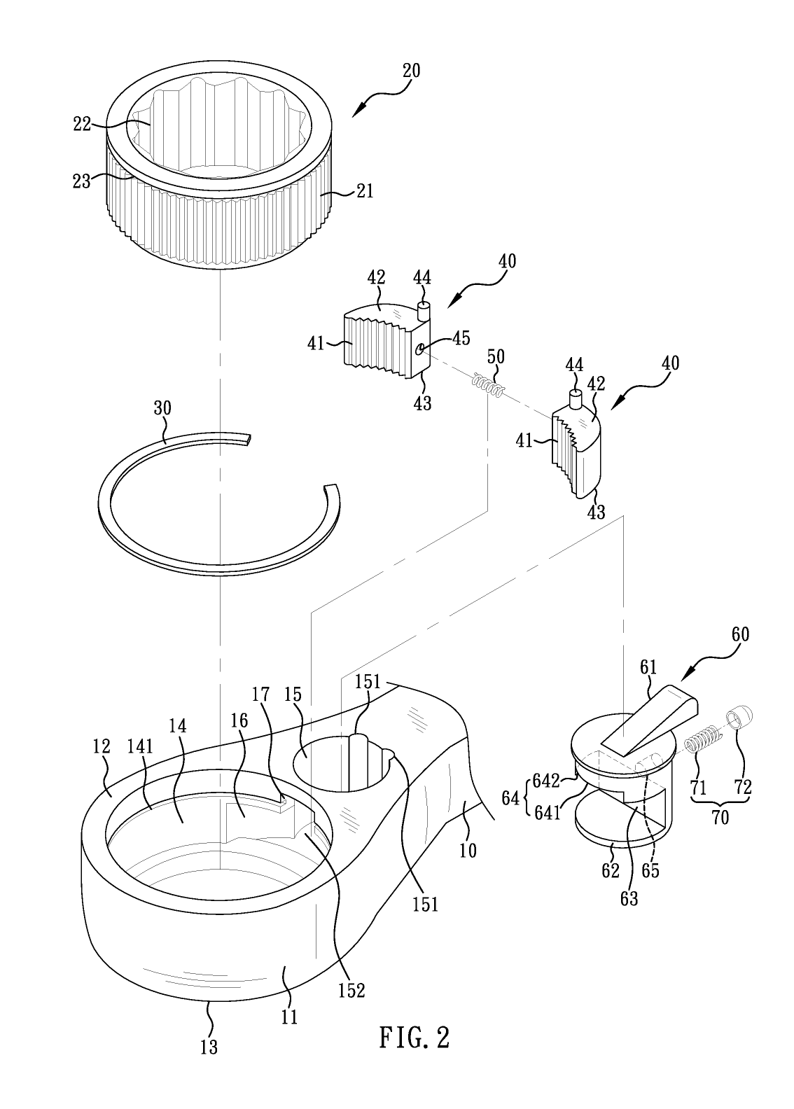

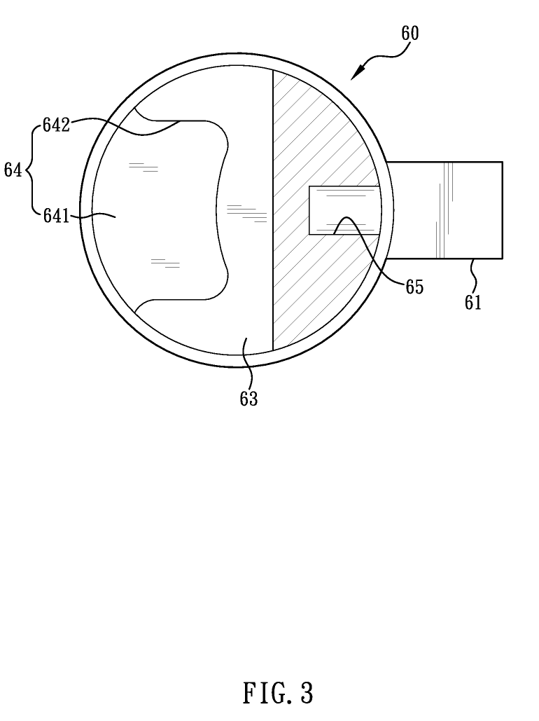

Referring to FIG. 1 to FIG. 6, the ratchet wrench structure comprises a body 10, a ratchet block 20, two locking members 40, a direction controller 60, and a positioning device 70.

The body 10 has one end thereof provided with a head portion 11. The head portion 11 is provided with a first side 12 and an opposite second side 13, with a first housing 14 passing through the first side 12 and the second side 13. The first housing 14 is formed in a round recess shaped, wherein one side of the first housing 14 is connected with a second housing 15. The second housing 15 opens toward the first side 12, wherein a third housing 16 is disposed between and connected with the first housing 14 and the second housing 15. Further, a ring recess 141 is disposed in the first housing 14 adjacent to the first side 12. The ring recess 141 and the first housing 14 are in axial alignment. A notch 17 is disposed between the ring recess 141 and the third housing 16 and positioned in vertical with the central axis of the first housing 14. Also, the distance from the notch 17 to the first side 12 is smaller than the distance from the ring recess 141 to the first side 12.

The ratchet block 20 is rotatably disposed in the first housing 14 and peripherally provided with plural teeth 21. A driving groove 22 passes through the center of the ratchet block 20. The inner edge of the driving groove 22 is provided with plural angles. Also, one end of the ratchet block 20 is peripherally provided with a ring notch 23. Therefore, by use of a C-clamp 30 disposed between the ring notch 23 and the ring recess 141, the ratchet block 20 is disposed in the first housing 14 of the body 10.

The two locking members 40 are disposed in the third housing 16 and capable of moving laterally. One side of each locking member 40 is provided with a tooth portion 41 for engaging the teeth 21. Each locking member 40 is provided with a flat-shaped top surface 42 and bottom surface 43 in opposite to the top surface 42. Each top surface 42 is provided with a pillar 44 protruding adjacent to an edge thereof, respectively. In addition, a resilient member 50 is disposed between the two locking members 40. Also, the two locking members 40 are provided with an engaging recess 45, respectively, wherein the two engaging recesses 45 correspondingly face each other, so as to receive the resilient member 50.

The direction controller 60 is pivotally disposed in the second housing 15. An upper end of the direction controller 60 is provided with a switch portion 61, while a lower end thereof is provided with a holding portion 62, wherein a receiving portion 63 is connected with and disposed between the switch portion 61 and the holding portion 62, such that the switch portion 61 and the holding portion 62 are mutually spaced. The receiving portion 63 partially receives the two locking members 40, and the holding portion 62 holds the bottom surfaces 43 of the two locking members 40. A direction controlling recess 64 is disposed at the bottom lateral side of the switch portion 61 facing the holding portion 62. The direction controlling recess 64 receives the pillars 44 of the two locking members 40. Also, the direction controlling recess 40 is further provided with an opening end 641 expanding outward and two side walls 642 positioned on two sides of the inner edge of the opening end 641. The two side walls 642 push the pillars 44 of the two locking members 40, so as to control the engagement between the two locking members 40 and the ratchet block 20.

In addition, the width of the opening end 641 of the direction controlling recess 64 is larger than the normal distance between the pillars 44 of the two locking members (when the resilient member 50 is not compressed). Therefore, the two locking members 40 are efficiently installed into the direction controlling recess 64 of the direction controller 60.

The positioning device 70 is disposed between the direction controller 60 and the inner wall of the second housing 15 for positioning the direction controller 60, such that the direction controller 60 drives the two locking members 40 to engage the ratchet block 20 and thereby control the ratchet block 20 to drive an object in clockwise or counterclockwise direction. The positioning device 70 includes a spring recess 65 disposed on the back of the direction controller 60, such that a spring 71 and a resisting member 72 are orderly disposed therein. Also, two positioning grooves 151 are disposed on the inner side of the second housing 15 and arranged in parallel to the central axis line of the first housing 14, whereby the resisting member 72 is pushed by the spring 71 and thus positioned in one of the positioning grooves 151. In embodiments of the present invention, the resisting member 72 is hollow and internally pushed by the spring 71.

Furthermore, in the embodiments of the present invention, the bottom side of the second housing 15 is provided with an inner recess 152. The inner recess 152 forms a stair shape in the third housing 16, where—on the holding portion 62 is pivotally disposed, such that the direction controller 60 is pivotally disposed in the second housing 15 without the necessity of using additional element, thus saving the cost.

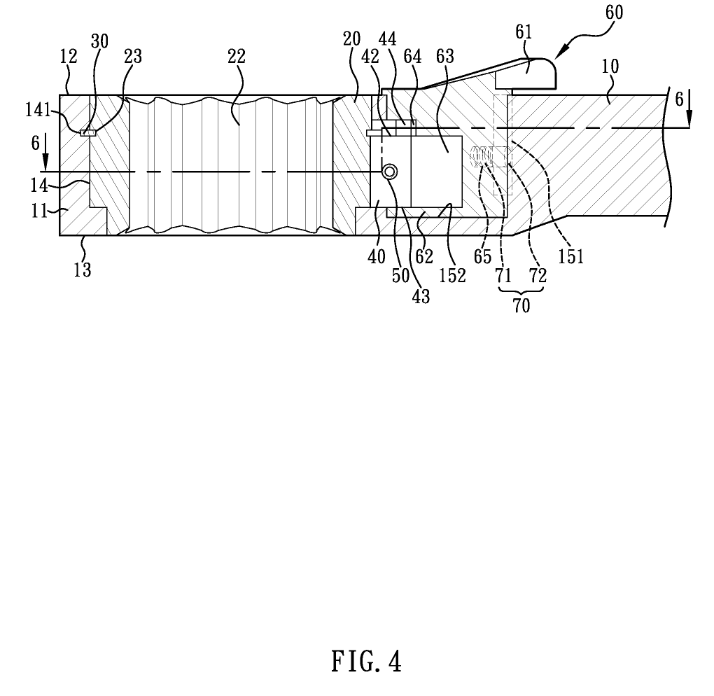

Referring to FIG. 4, due to the holding portion 62 of the direction controller 60 holding the bottom surfaces 43 of the two locking members 40, the locking members 40 are prevented from detaching from the holding portion 62. Therefore, the top surfaces 42 and the bottom surfaces 43 of the two locking members 40 are kept in a flat shape. As a result, the stable structures of the two locking members 40 are maintained, so that the torque provided by the present invention is not decreased.

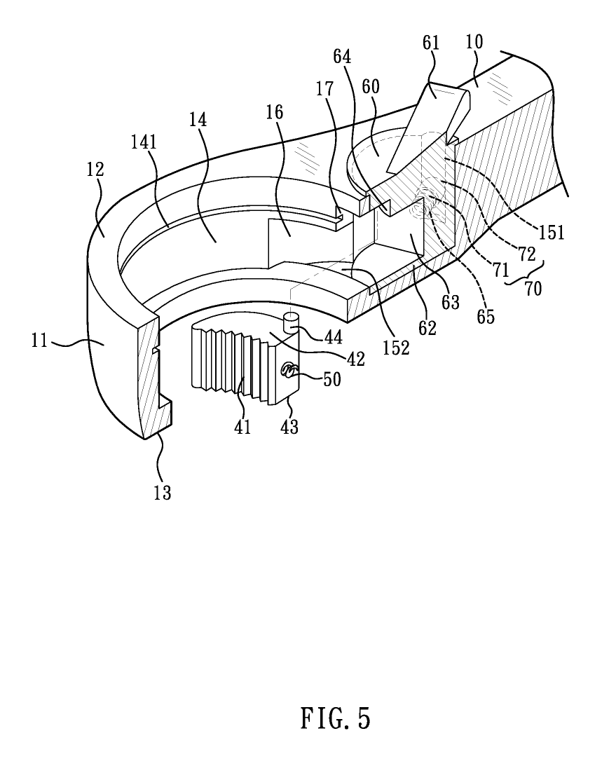

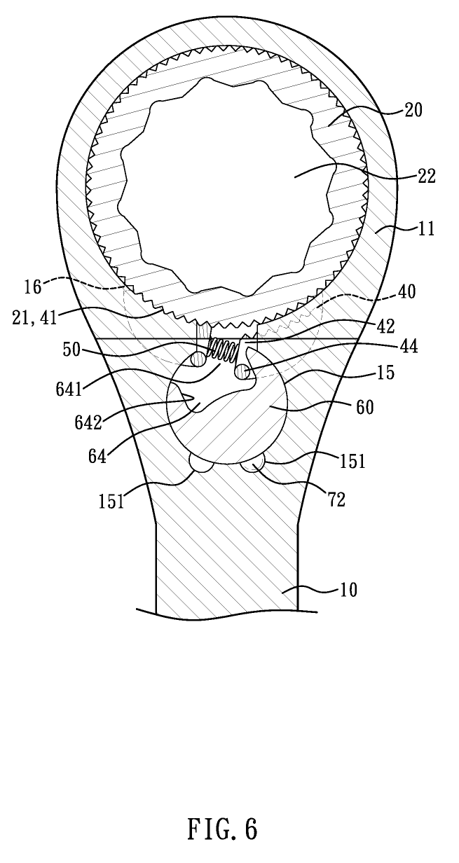

Referring to FIG. 5 and FIG. 6, during the assembling process of the present invention, the notch 17 between the ring recess 141 and the third housing 16 enables the pillars 44 of the two locking members 40 to freely pass through the notch 17 into the direction controlling recess 64. Also, due to the width of the opening end 641 of the direction controlling recess 64 being larger than the normal distance between the pillars 44 of the two locking members 40, during the assembling process, the two locking members 40 are able to be efficiently installed into the direction controlling recess 64 without the necessity to compress the resilient member 50 by use of the two locking members 40, thus facilitating the assembling process.

Furthermore, by switching the direction controller 60 and by use of the positioning effect provided by the positioning device 70, the direction controller 60 is optionally positioned in one of the positioning grooves 151, such that one of the locking members 40 is engaged with the ratchet block 20, whereby the ratchet wrench is used to drive a to-be-screwed object in clockwise or counterclockwise direction.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A ratchet wrench structure, comprising:
a body provided with a head portion on one end thereof, the head portion provided with a first side and a second side in opposite to the first side, a first housing passing through the first side and the second side, one side of the first housing connected with a second housing, the second housing opening toward the first side, a third housing disposed between and connected with the first housing and the second housing;
a ratchet block rotatably disposed in the first housing and peripherally provided with plural teeth;
two locking members disposed in the third housing and laterally movable, one side of the two locking members provided with a tooth portion engaging the teeth, a resilient member disposed between the two locking members, each locking member provided with a flat top surface and a flat bottom surface in opposite to the top surface, each top surface provided with a protruding pillar, respectively;
a direction controller pivotally disposed in the second housing, at an upper end thereof provided with a switch portion, a lower end thereof provided with a holding portion, and a receiving portion disposed between the switch portion and the holding portion, the switch portion and the holding portion mutually spaced, the receiving portion partially receiving the two locking members, the holding portion holding the bottom surfaces of the two locking members, a direction controlling recess disposed at a bottom lateral side of the switch portion facing the holding portion, the direction controlling recess receiving the pillars of the two locking members, the direction controlling recess provided with an opening end expanding outward; and
a positioning device disposed between the direction controller and an inner wall of the second housing and positioning the direction controller, the direction controller thereby driving the two locking members to engage the ratchet block such that the ratchet block is controlled to drive an object in clockwise or counterclockwise direction.

2. The ratchet wrench structure of claim 1, wherein a ring recess is disposed in the first housing adjacent to the first side, the ring recess arranged in axial alignment with the first housing, one end of the ratchet block peripherally provided with a ring notch, a C-clamp disposed between the ring notch and the ring recess.

3. The ratchet wrench structure of claim 2, wherein a notch is disposed between the ring recess and the third housing.

4. The ratchet wrench structure of claim 3, wherein the notch is positioned in vertical to a central axis of the first housing.

5. The ratchet wrench structure of claim 1, wherein the positioning device includes a spring recess disposed on a back of the direction controller, and an inner side of the second housing is provided with two positioning grooves, such that a resisting member and a spring are disposed in the spring recess and in the two positioning grooves, whereby the resisting member is positioned.

6. The ratchet wrench structure of claim 5, wherein the resisting member is hollow.

7. The ratchet wrench structure of claim 1, wherein a bottom side of the second housing is provided with an inner recess, the inner recess forming a stair shape in the third housing, whereon the holding portion is pivotally disposed.

8. The ratchet wrench structure of claim 1, wherein the two locking members are provided with an engaging recess, respectively, wherein the two engaging recesses correspondingly face each other, so as to receive the resilient member.

9. The ratchet wrench structure of claim 1, wherein a width of the opening end of the direction controlling recess is larger than a normal distance between the pillars of the two locking members when the resilient member is not compressed.
